(19) United States
(12) Patent Application Publication
(10) Pub. No.: US 2010/0187301 A1
(43) Pub. Date: Jul. 29, 2010

(54) MULTIMEDIA NAME CARD MANAGEMENT SYSTEM

(76) Inventor: Kuo-Shen LIU, Taipei (TW)

Correspondence Address: LEONG C LEI, PMB # 1008, 1867 YGNACIO VALLEY ROAD, WALNUT CREEK, CA, 94598, US

(21) Appl. No.: 12/358,247

(22) Filed: Jan. 23, 2009

(51) Int. Cl. G06K 5/00

(52) U.S. Cl. 235/380

(57) ABSTRACT

Disclosed in a multimedia name card management system in which a driver program and hardware are prior installed in a user end and internet is used as a transmission medium so that by using a one dimensional barcode scanner device to scan a one dimensional barcode printed on the name card at user end and establishing connection with a web site name card management system in which multimedia name cards are stored, personal data of the name card owner can be accessed. The management system allows the user end to access the web site by using password for recording or revision of stored personal data, and setting of other functions, so as to realize a multimedia name card function of efficient look-up and convenient revision. The present invention also allows selected personal data to be transmitted in a wireless manner from the computer to a mobile phone or a personal digital assistant (PDA) for storage.

### TECHNICAL FIELD OF THE INVENTION

The present invention generally relates to a multimedia name card management system, and particularly to a multimedia name card management system that realizes efficient look-up and convenient revision by employing a one-dimensional barcode that is read Vis Internet for recording and revision of personal data and setting of other functions.

### DESCRIPTION OF THE PRIOR ART

A traditional name card is printed to display some personal data to allow other persons to easily understand information of the individual or his or her company. Those data include name, company address, web site, telephone number, MSN/Skype ID, mobile phone number, and facsimile number, as well as company logo. Often, those data are printed with both local language and English. However, the amount of data that can be shown on a name card is limited and it is generally impossible to show all the desired data on a single name card, such as personal web site, blog, e-mail address, resume, interest, specialty background, photo, and even dynamic audio/video data.

Modern people often possess mobile phones. However, it is not easy to key in the above mentioned data by using a mobile phone. A lot of companies are making name card scanners, such as Hyundai of Korea, Penpower Technology, Ltd. of Taiwan, I.R.I.S. of Belgium, Sino Mind Innovation Ltd., Sky Microwave Co., Ltd of China, and Foresoon Engineering Co., Ltd. of Hong Kong. However, these known scanners have the following disadvantages:

(1) These scanners are expensive (costing around US$200);

(2) They may get mistaken for non-standard character fonts;

(3) They can only get the limited data printed on a name card;

(4) They do not allow a name card owner to timely update the data;

(5) They are not able to read all foreign characters.

Further, U.S. Pat. No. 5,483,052 teaches printing a two-dimensional barcode on a name card and accessing the contents of the two dimensional barcode using a two dimensional barcode reader, but it is disadvantageous for the following:

(1) Although a two dimensional barcode can encode more data than a one dimensional barcode, it still does not meet the need for the great amount of data mentioned above and it is even impossible to record multimedia message including motion pictures and sounds;

(2) A two dimensional barcode reader is more costly;

(3) A two dimensional barcode occupies a larger amount of space on a name card;

(4) Persons that have not purchased a barcode machine are not able to input data; and

(5) The data printed on a name card cannot be timely updated by the owner.

Mobile phones that are currently available are capable to read QR codes. Storing personal data in QR codes still encounter the same problems. Further, wireless bandwidth of the mobile is a bottleneck for connection with a network and it is not fast enough for transmission of multimedia data and requires high communication expense. Further, a display screen of a mobile phone is too small to display a lot of data.

In view of these problems, the present inventor, based on years' experience in this business, conducted repeated researches and experiments and developed a multimedia name card management system, aiming to realize efficient look-up and convenient revision of name cards so as to overcome the drawbacks of the known techniques.

### SUMMARY OF THE INVENTION

The primary objective of the present inventor is to provide a multimedia name card management system, which realizes efficient look-up and convenient revision by employing a one-dimensional barcode that is read by a network for recoding or revision of personal data and setting of other functions.

The multimedia name card management system is to first install a driver program and hardware in a user end, and a network is used as a transmission measure so that by using a one dimensional barcode scanner device to scan a one dimensional barcode printed on a name card at the user end and establishing connection with a web site name card management system in which multimedia name cards are stored, personal data of the name card owner can be accessed. The management system allows the user end to access the web site by using password for recording or revision of stored personal data, and setting of other functions, so as to realize a multimedia name card function of efficient look-up and convenient revision.

With such a multimedia name card management system, selected personal data can also be transmitted in a wireless manner from the computer to a mobile phone or a personal digital assistant (PDA) for storage.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a system block diagram of the present invention.

FIG. 2 is a perspective view of a user-end device of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention uses a one-dimensional barcode printed on a name card and employs a barcode scanner device to scan and read the barcode. The barcode scanner device itself is connected to a computer by USB (wired) or wireless means. When scanned data are read into the computer, pre-installed software is activated to establish connection with a barcode multimedia name card integration system web site through the Internet for carrying out various operation of name card management.

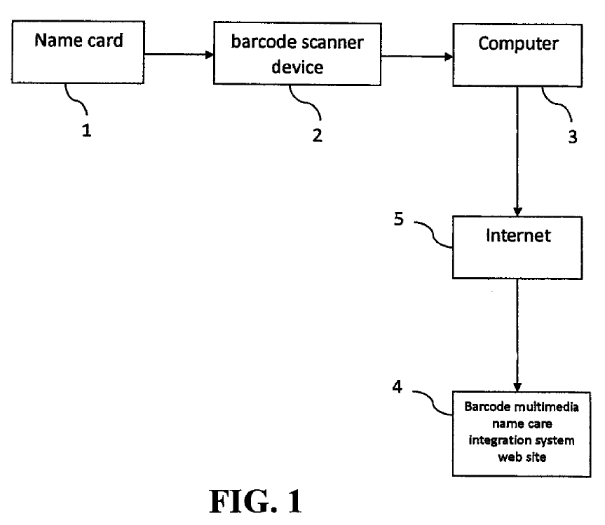

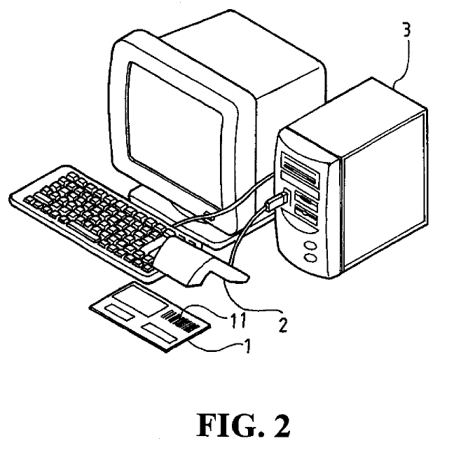

Referring to both FIGS. 1 and 2, the present invention is comprised of four sections, generally including a name card 1 on which a one-dimensional barcode 11 is printed; a barcode scanner device 2, which is connected to a computer 3 through USB connection or in a wireless manner for reading the barcode data; driver software installed in the computer 3 for transmitting the data of one-dimensional barcode 11 through Internet 5 to a computer in a web site; and a barcode multimedia name card integration system web site 4, which establishes various mechanisms of name card management. The barcode multimedia name card integration system web site 4 is a web site that includes a member management mechanism and contains data, such as text, image, and voice. A member enters the web site by inputting a password to carry out addition, modification, and look-up of established name card data and personal data of the member himself/herself.

The name card 1 may contain alphanumeric characters at a location below the one-dimensional barcode 11 so as to allow the user, besides using the barcode scanner device 2 to scan, to look up the data associated with the name card user by entering the printed alphanumeric characters through a keyboard.

The barcode multimedia name card integration system has the following functions:

(a) automatically reading the data of one-dimensional barcode 11 and transform to the web site;

(b) downloading data of name card 1 from Barcode multimedia name card integration system web site 4 to a personally owned computer 3;

(c) immediately displaying data associated with a name card after the one-dimensional barcode 11 of the name card 1 is scanned;

(d) member management function including addition/modification of membership data and addition/modification/deletion of name card data and, for a user modifying his or her personal data, the system automatically informing all users who have scanned the name card;

(e) supporting full text searching (namely by entering any keyword) of names of friends/relatives.

Besides being operated with a web site, the barcode multimedia name card integration system in accordance with the present invention can downward data to a personally owned computer and further, by using the function of connection of the computer with a mobile phone or a personal digital assistant (PDA), name card data may also be transmitted to the mobile phone and PDA to make communication with friends/relatives easy; or only a preset selected data is transmitted.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multimedia name card management system, comprising:
a web site, which provides a multimedia name card integration system web site accessible by member with a password;
a one-dimensional barcode, which is specific to a given individual member and is printed on his name card; and
a user employing a barcode reader to read the individual specific one-dimensional barcode printed on the name card and accessing the multimedia name card management system web site through Internet to fast access personal data of the member recorded in the web site so as to realize efficient look-up of the multimedia name card.

2. The multimedia name card management system according to claim 1, wherein the barcode multimedia name card integration system web site comprises a web site that comprises a data management mechanism containing text, image, and voice.

3. The multimedia name card management system according to claim 1, wherein name cards belonging to the user are automatically and sequentially sorted in accordance with alphabet, number of stroke, or date for easy look-up.

4. The multimedia name card management system according to claim 1, wherein the user end is allowed to key in a keyword for carrying out full text searching through the name cards owned thereby.

5. The multimedia name card management system according to claim 1, wherein the barcode name card management web site system is a password device to allow the member to prevent other persons from modifying the personal data.

6. The multimedia name card management system according to claim 1, wherein alphanumeric characters are printed below the barcode to allow the user to carry out input through a keyboard instead of using the barcode scanner device for looking up the data of the name card.

7. The multimedia name card management system according to claim 1, wherein the system automatically informs of all users who have scanned the member's name card when the member modifies personal data.

8. The multimedia name card management system according to claim 1, wherein the name card data owned by the user is transmitted in a wireless manner to a mobile phone or personal digital assistant thereof or only a preset selected data is transmitted.
